(19) United States
(12) Patent Application Publication
(10) Pub. No.: US 2026/0206734 A1
(43) Pub. Date: Jul. 23, 2026

(54) Fishing Rod and Reel Locking Device

(71) Applicant: Andrew Ramsey Fonda, Culpeper, VA (US)

(72) Inventor: Andrew Ramsey Fonda, Culpeper, VA (US)

(21) Appl. No.: 19/032,101

(22) Filed: Jan. 19, 2025

(51) Int. Cl. A01K 97/10; A01K 89/02

(52) U.S. Cl. CPC A01K 97/10; A01K 89/02

(57) ABSTRACT

A two-part system for securing a fishing rod and reel into a fishing rod holder. This system embodies a design that provides a Lock Loop on the top part to insert through a Lock Loop Slot on the bottom part. The top part secures around the fishing rod and reel by way of a fishing pole loop, and the bottom part secures into the bottom of the fishing rod holder via the inner sleeve. The bottom part outer sleeve has the Lock Loop Slots that the top part Lock Loop inserts through. Once the two parts are secured together, the user can then use their own padlock to lock the system via insertion through the Lock Loop. This will then secure (lock) the fishing rod and reel to the fishing rod holder and preventing theft of the fishing rod and reel.

### B.2. CROSS-REFERENCE TO RELATED APPLICATIONS

There are no other applications to cross reference to.

### B.3. STATEMENT REGARDING FEDERALLY SPONSORED RESEARCH OR DEVELOPMENT

There has been NO federally sponsored research or development.

### B.4. THE NAMES OF THE PARTIES TO A JOINT RESENUMBERARCH AGREEMENT

There are no other parties, and there is no joint research agreement.

### B.5. AN INCORPORATION BY REFERENCE STATEMENT REGARDING THE MATERIAL IN

One or more ASCII plain text files, submitted via the USPTO patent electronic filing system or on one or more read-only optical discs (see § 1.52(e)(8)), identifying the names of each file, the date of creation of each file, and the size of each file in bytes, for the following document types:

There are no ASCII Plain Text Files incorporated by reference.
A “Computer Program Listing Appendix” (see § 1.96(c));

There are no computer program listing appendices incorporated by reference.
(B) A “Sequence Listing” (see § 1.821(c)); or

There is no sequence listing incorporated by reference.
(C) “Large Tables” (see § 1.58(c)).

There are no large tables incorporated by reference.
(ii) An XML file for a “Sequence Listing XML” (see § 1.831(a)), submitted via the USPTO patent electronic filing system or on one or more read-only optical discs (see § 1.52(e)(8)), identifying the names of each file, the date of creation of each file, and the size of each file in bytes.

There is no XML file for a “Sequence Listing XML” incorporated by reference.

### B.6. STATEMENT REGARDING PRIOR DISCLOSURES BY THE INVENTOR OR A JOINT INVENTOR

There are no prior disclosures.

### B.7. BACKGROUND OF THE INVENTION

This fishing rod and reel locking system is my own original idea and invention. I am an avid surf fisherman and have a fishing rod rack on the front of my truck. I have had several fishing rods and reels stolen out of the fishing rod rack on my truck on two different occasions amounting to thousands of dollars in loss. Unfortunately, this problem occurs widely. Fishing rods and reels are commonly carried and stored in fishing rod holders (also known as rod racks or rod holders) mounted on different types of vehicles from cars, trucks, bicycles, and boats. My invention secures the fishing rod and reel to the fishing rod holder to prevent theft. It was my goal to invent a locking system that would be affordable, allow for the use of the buyers own padlocks, and be easy to use.

### B.8. BRIEF SUMMARY OF THE INVENTION

This fishing rod and reel locking system is designed to secure the fishing rod and reel in a fishing rod and reel holder (rod rack, rod holder). This is a two-part system. The top part (Part A) is designed to wrap around the fishing rod and reel while the rod and reel is in the rod rack and secure it for safety. The length can vary depending on the application and size of the fishing rod rack/holder. Part A has a Lock Loop which is designed to fit through an opening on the Part B Outer Sleeve Lock Loop Slots. Part B has an inner sleeve that inserts into the fishing rod rack/holder and then the Part A Lock Loop inserts into one of the Part B Lock Loop Slots to secure the fishing rod and reel to the fishing rod holder. There are multiple Lock Loop Slots on the Part B to allow for fitment to various sized rod racks and rod holders. Once this locking system is secured in place, a padlock can then be used on the Part A Lock Loop to lock the system in place. The padlock(s) are supplied by the user so they can use their choice of padlock. Depending on the size of the fishing rod holder, the length of Part A will vary and the length of Part B will vary. Additionally, the number of Lock Loop Slots may also vary. This variable sizing will accommodate different fishing rod rack and rod holder applications such as fishing rod racks on cars and trucks, and fishing rod racks on boats.

### B.9. BRIEF DESCRIPTION OF THE SEVERAL VIEWS OF THE DRAWING

There are six views of the drawings. Below is a description of each drawing:

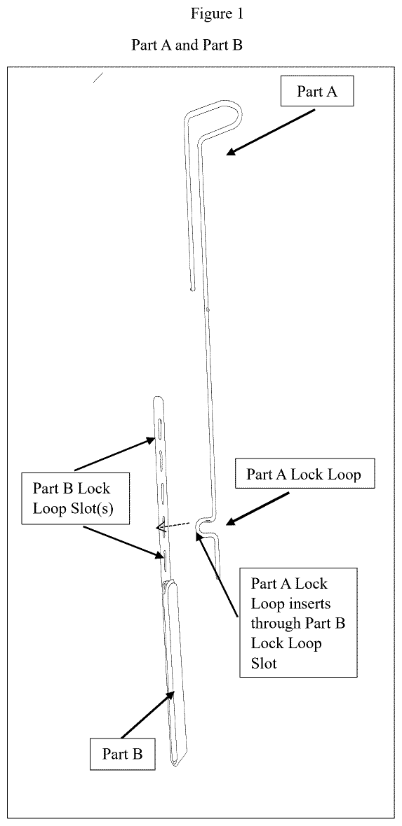

Drawing FIG. 1: this drawing illustrates both Part A and Part B and how the two parts work together. The drawing illustrates with an arrow how the Part A Lock Loop inserts through the Part B Lock Loop Slot.

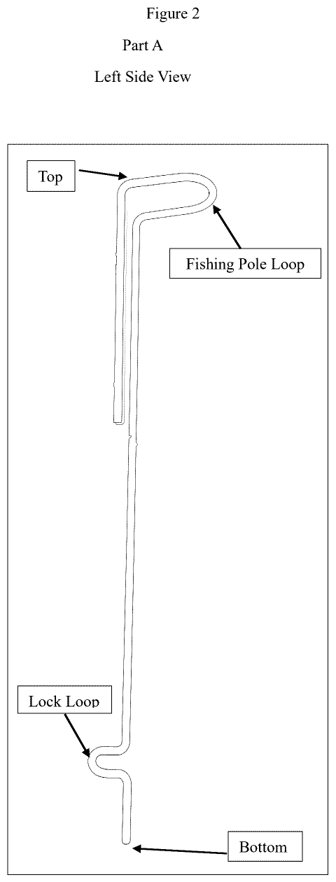

Drawing FIG. 2: this drawing illustrates a left side view of the Part A.

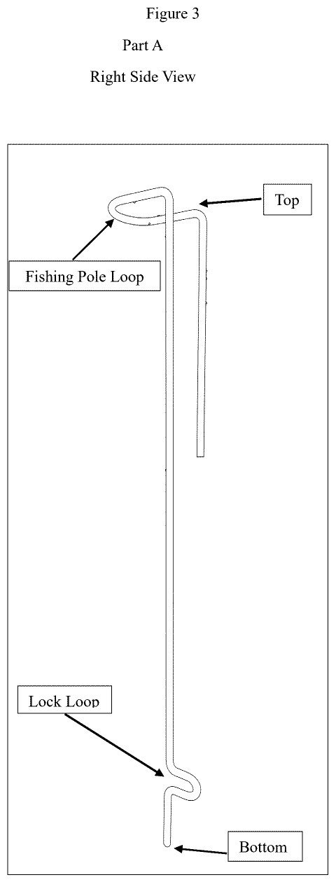

Drawing FIG. 3: this drawing illustrates a right side view of the Part A.

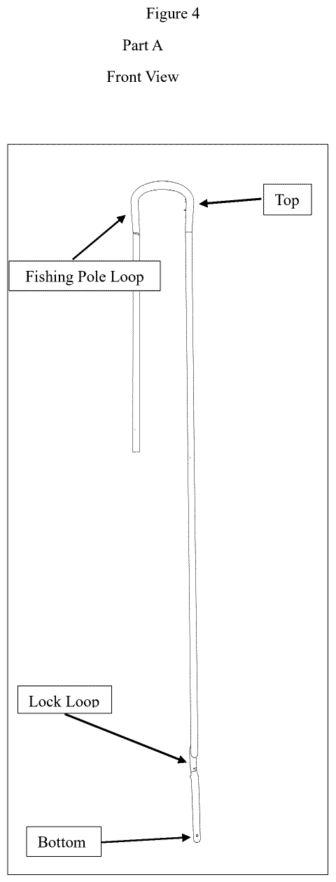

Drawing FIG. 4: this drawing illustrates a front view of the Part A.

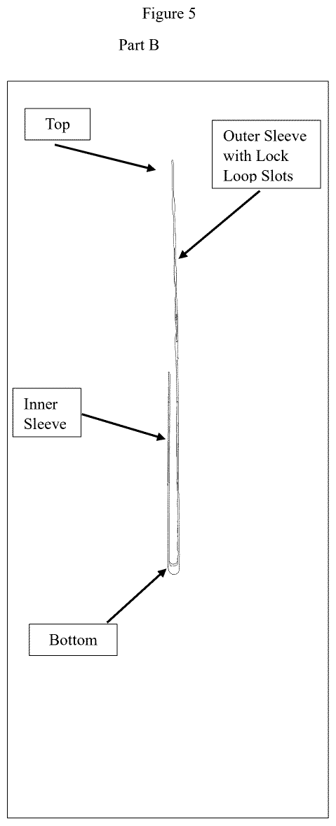

Drawing FIG. 5: this drawing illustrates a side view of the Part B.

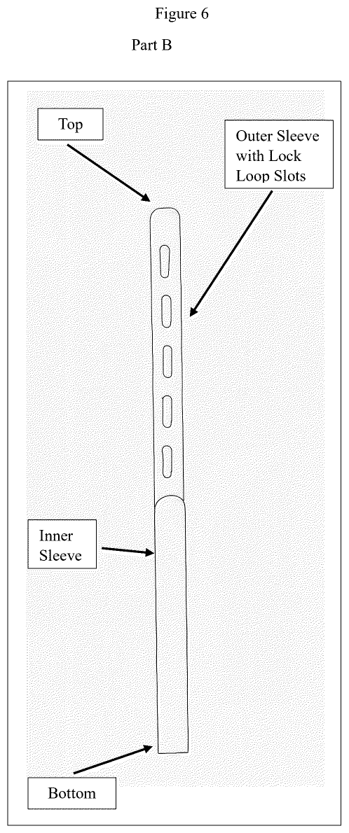

Drawing FIG. 6: this drawing illustrates a front view of the Part B.

### B.10. DETAILED DESCRIPTION OF THE INVENTION

In the following detailed description of the invention, numerous details, examples, and embodiments of the invention are described. The invention is not limited to the embodiments set forth and can be adapted for many applications, shapes, sizes, materials, coatings, and manufacturing processes. The elements mentioned in this description are not all encompassing and are not intended to limit the invention to just these elements. The device of the present disclosure is to be used to secure a fishing rod and reel to a fishing rod rack or rod holder. Because fishing rod racks and rod holders come is various sizes and applications is it essential that this invention be adaptable in different sizes. The use of this device is for safety and primarily the prevention of theft of the fishing rod and reel.

### Part A: (Refer to Drawing FIGS. 1,2, 3, and 4)

The top part (Part A) is designed to wrap around the fishing rod and reel by way of the Fishing Pole Loop while the rod and reel is in the rod rack and secure it for safety. The top of Part A Fishing Pole Loop fits around the fishing rod and secures around the fishing rod rack/holder. The length and size of Part A can vary depending on the application and size of the fishing rod rack/holder. Part A has a Lock Loop at the bottom which is designed to fit through an opening on the Part B Outer Sleeve Lock Loop Slots.

### Part B: (Refer to Drawing FIGS. 1, 5, and 6)

The bottom part (Part B) has an inner sleeve that inserts into the bottom of the fishing rod rack/holder and then the Part A Lock Loop inserts into one of the Part B Lock Loop Slots to secure the fishing rod and reel to the fishing rod rack/holder. The length and size of Part B can vary depending on the application and size of the fishing rod rack/holder. There are multiple Lock Loop Slots on the Part B to allow for fitment adjustment to various sized rod racks and rod holders. The number of Lock Loop Slots may vary depending on the application of the device. Part B material is sufficiently thin enough to insert into the bottom of a fishing rod rack/holder to fit between the bottom of the fishing rod and the inner wall of the fishing rod rack/holder. The Part B inner sleeve is of sufficient length that when attached with the Part A Lock Loop the inner sleeve will not hang out of the bottom of the fishing rod rack/holder.

### Materials:

The different embodiments of this invention allow for the use of virtually any materials that are sufficiently durable and strong to prevent easy breakage. The invention may also use coatings such as rubberized coatings or plastics to aide in the prevention of environmental damage such as rust and corrosions on metal elements.

### Manufacturing:

Various manufacturing processes could be used in the embodiment of the process to make the device Part A and Part B. Manufacturing process would depend on the material being used. Any person skilled in the art or science to which the invention or discovery appertains should be able to make and use it. The type of process would depend on the type of material used.

The Part A manufacturing process could be of various types to include but not limited to wire forming, metal forming, injection molding, thermoforming, heat bending, rotational molding, compression molding, vacuum casting, pultrusion, or other such processes to form the desired embodiment of the Part A.

The Part B manufacturing process could be of various types to include but not limited to wire forming, metal forming, metal stamping, injection molding, thermoforming, heat bending, rotational molding, compression molding, vacuum casting, pultrusion, or other such processes to form the desired embodiment of the Part B.

For this device, the best mode contemplated by the inventor of carrying out the embodiment of the invention would be the use of rod forming for Part A and metal stamping for the Part B. Both Part A and Part B material would be a metal such as steel or aluminum, and would be sprayed with a rubberized coating to prevent environmental corrosion. The inventor also views the embodiment of the invention using strong and durable plastic material for Part A and Part B as a desirable process due to corrosion resistant properties of the material.

### Use of the Invention/Device (Mode of Operation):

The invention is for the prevention of theft of a fishing rod and reel while inserted into a fishing rod rack or fishing rod holder. Once the fishing rod and reel are inserted into the fishing rod rack or rod holder, the Part A would then be secured around the fishing rod and reel at the top of the fishing rod holder. Once that is done, the Part B would then be inserted into the bottom of the fishing rod holder and one of the Part B Loop Lock Slots would be aligned with the Part A Lock Loop. The Part A Lock Loop would then be inserted through the Part B Lock Loop Slot. Once these steps are completed, a padlock (which is not part of this invention) would be secured through the Part A Lock Loop.

1. A fishing rod and reel locking device, comprising: a top part; the top part comprising a fishing pole loop and lock loop; a bottom part; the bottom part comprising an outer sleeve, an inner sleeve and one or more lock loop slots located on the outer sleeve of said bottom part; wherein the fishing rod and reel locking device is configured to have said top part securing a fishing rod and reel to a top of a rod holder, said bottom part be secured into a bottom of the rod holder by the inner sleeve of the bottom part, and the lock loop of the top part inserted through one of the lock loop slots of the bottom part.
